(19) United States
(12) Patent Application Publication
(10) Pub. No.: US 2013/0032444 A1
(43) Pub. Date: Feb. 7, 2013

(54) METHOD FOR CONTROLLING AN AUTOMATED CLUTCH

(71) Applicant: SCHAEFFLER TECHNOLOGIES AG & CO. KG, Herzogenaurach (DE)

(72) Inventors: Markus Baehr, Buehl (DE); Juergen Gerhart, Appenweier (DE); Viktor Franz, Karlsruhe (DE)

(73) Assignee: SCHAEFFLER TECHNOLOGIES AG & CO. KG, Herzogenaurach (DE)

(21) Appl. No.: 13/649,878

(22) Filed: Oct. 11, 2012

Related U.S. Application Data
(63) Continuation of application No. PCT/DE2011/000307, filed on Mar. 24, 2011.

(30) Foreign Application Priority Data
Apr. 12, 2010 (DE) 102010014678.1

(51) Int. Cl. F16D 25/12

(52) U.S. Cl. 192/85.63; 701/68

(57) ABSTRACT

A method for controlling an automated clutch (10) that is actuated by a hydraulic clutch actuating system including a hydrostatic actuator (19) whose pressure is detected, comprising the step of using the detected pressure of the hydrostatic actuator (19) to detect and avoid undesired overloading of the actuator (19), of the clutch, and/or of at least one auxiliary device associated with the clutch (10) or with the actuator (19).

### CROSS-REFERENCE TO RELATED APPLICATIONS

This application is filed under 35 U.S.C. §120 and §365(c) as a continuation of International Patent Application No. PCT/DE2011/000307 filed Mar. 24, 2011 and claiming priority of German Patent Application No. 10 2010 014 678.1 filed Apr. 12, 2010, which applications are incorporated herein by reference in their entireties.

### FIELD OF THE INVENTION

The invention relates to a method for controlling an automated clutch that is actuated by a hydraulic clutch actuating system including a hydrostatic actuator whose pressure is detected.

### BACKGROUND OF THE INVENTION

Published German Patent Application DE 197 00 935 A1 discloses a device for actuating a clutch in the drive train of a motor vehicle. Published German Patent Application DE 10 2009 009 145 A1 discloses a clutch system including a hydrostatic clutch release system wherein deviations of an opening behavior of a connecting opening are detected by determining the pressure behavior of the clutch release system as a function of an actuating speed of a master cylinder piston. The evaluation of the pressure conditions as a function of the actuating path of the clutch can be done by means of a pressure sensor that is integrated into the clutch release system, for instance in the master or slave cylinder or in a pressure line.

### BRIEF SUMMARY OF THE INVENTION

In accordance with a preferred embodiment of the method, a pressure signal of a pressure sensor that detects the pressure of the hydrostatic actuator is evaluated and processed. The pressure sensor may be integrated in a hydrostatic master of the clutch actuator system. The evaluation and processing of the pressure signal are preferably carried out in at least one control associated with the clutch actuating system or drive train of a motor vehicle in which the clutch and clutch actuating system are integrated.

In accordance with a further preferred exemplary embodiment of the method, the pressure signal is compared to a first pressure limit and an actuator drive is deactivated when the first pressure limit is exceeded. This is done to allow the clutch actuating system to relax due to a passive movement of the actuating system. The method is very simple and robust and therefore easy to implement.

In accordance with a further preferred exemplary embodiment of the method, the pressure signal is compared to the first pressure limit in an actuator control. The actuator control comprises, for example, an actuator control device into which a position control for the actuator may be integrated. In conventional systems, the actuator control device assumes monitoring functions, for example.

In accordance with a further preferred exemplary embodiment of the method, the pressure signal is compared to a pressure limit or to the first or to a second pressure limit in a drive train control. The drive train control, for example, comprises a drive train control device that can react to a change in the pressure signal as required by the situation in a way to ensure that the driving comfort is not or only negligibly affected.

In accordance with a further preferred exemplary embodiment of the method, a higher pressure value is used for the first pressure limit than for the second pressure limit. If the second pressure limit is exceeded, the reaction preferably does not involve any or involves only slight consequences on the behavior of the vehicle. If the first pressure limit is exceeded, a self-protective function such as an emergency shut-down is initiated for the clutch or the clutch actuating system.

In accordance with a further preferred exemplary embodiment of the method, the actuator is moved slightly by the actuator drive to compensate a pressure increase detected by the pressure sensor. In this context “slightly” is understood to mean that the actuator is moved in a way that the pressure compensation is not or only negligibly perceptible to the driver of the motor vehicle.

In accordance with a further preferred exemplary embodiment of the method, a movement of the actuator as the clutch closes is decelerated if the pressure detected by the pressure sensor increases unexpectedly rapidly. By specifying an adapted target position for the actuator an undesired overload can reliably be prevented.

In accordance with further preferred exemplary embodiments of the method, the pressure signal is used for at least one, for multiple, or for each of the following clutch actuating functions:
determining currently attainable temperature-dependent actuator dynamics. This can be used to implement a situation-dependent limiting of the actuator dynamics.
detecting a reference mark in the clutch actuating system in particular in an engagement system of the clutch. The reference mark may be used to reference an incremental encoder of the actuating drive. The reference mark may likewise be used to determine a specific distance-dependent, force-dependent or pressure-dependent condition of the clutch actuating system.
determining a direction of movement of the clutch actuating system.
determining a load on the actuator, for example to determine a characteristic load curve.
   The characteristic load curve may, for instance, be used for a feed-forward controlling of the closed-loop position control.
determining a force hysteresis in the clutch actuating system. If friction in the clutch is low, it is likewise possible to determine the torque hysteresis on the clutch.
implementing a plausibility check for a reference mark of the actuator or of the clutch system for instance after a calibration of an incremental distance measurement in the actuator or engaging system.

In accordance with a further preferred exemplary embodiment of the method, the clutch is directly actuated via the hydrostatic actuator including a master cylinder and a slave cylinder. Directly actuated means that the hydrostatic pressure of the actuator acts directly on the clutch, in particular without interposed lever actuators.

An object of the invention is to extend the useful life of an automated clutch that is actuated by a hydraulic clutch actuating system including a hydrostatic actuator whose pressure is detected.

In a method for controlling an automated clutch that is actuated by a hydraulic clutch actuating system including a hydrostatic actuator whose pressure is detected, this object is attained by using the detected pressure or pressure value of the hydrostatic actuator to recognize and avoid an undesired overload of the actuator, of the clutch and/or of at least one auxiliary device associated with the clutch or actuator. The pressure of the hydrostatic actuator is detected, for example, by a pressure sensor on a master cylinder, a pressure line, or a slave cylinder, which represent parts of elements of the hydrostatic actuator. The auxiliary device may, for example, be a bearing device such as an apply bearing, which may be connected between a slave cylinder piston and the clutch. The clutch is preferably embodied as an actively closed clutch, in particular, as a directly actuated clutch or as a wet clutch. The method of the invention provides a simple and reliable way of protecting the clutch and/or the actuator and the associated hydrostatic system, respectively, against mechanical overload. In accordance with a further aspect of the invention, the clutch is embodied as a double clutch with actively closed individual clutches. The method of the invention provides a technical solution for detecting the beginning of an overload in a simple way. Due to a suitable reaction in the clutch actuation, undesired damage to the clutch, the actuator, or auxiliary devices associated therewith can be avoided.

### BRIEF DESCRIPTION OF THE DRAWINGS

Further advantages, features and details of the invention become apparent from the following detailed description of various exemplary embodiments with reference to the drawing.

FIG. 1 is a simplified representation of a clutch actuating system for actuating an automated friction clutch.

### DETAILED DESCRIPTION OF THE INVENTION

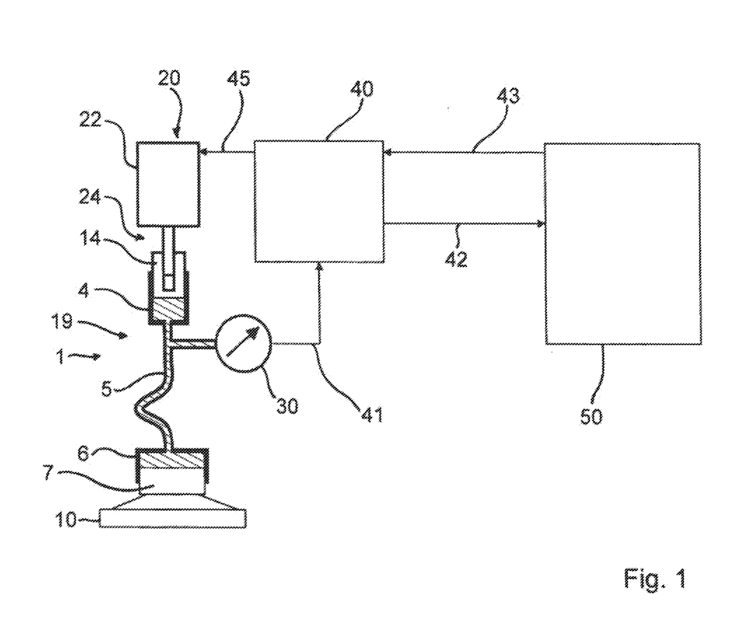

FIG. 1 is a simplified representation of a clutch actuating system 1 for an automated clutch 10, in particular an automated double clutch 10. The clutch actuating system 1 is associated with the clutch 10, embodied as a friction clutch, in a drive train of a motor vehicle. The clutch actuating system 1 comprises a master cylinder 4 connected to a slave cylinder 6 by a hydraulic line 5, also referred to as a pressure line. A slave piston 7 is movable to and fro in the slave cylinder 6. The slave piston directly actuates the clutch 10 via an actuating member and, preferably, an interposed bearing.

The master cylinder 4 is connectible to a compensation container via a connecting opening. A master piston 14 is movable to and fro in the master cylinder 4. The master cylinder 4, the hydraulic line 5, the slave cylinder 6, the slave piston 7, and the master piston 14 represent parts of a hydrostatic actuator 19 that is drivable by an actuator drive 20 in the form of an electric motor. The actuating drive 20 comprises an actuator motor 22 coupled to the master piston 14 by an actuating transmission 24. The actuator transmission 24 converts a rotary driving movement of the actuator motor 22 into a longitudinal movement or translatory movement of the master piston 14.

The hydraulic pressure in the hydraulic or hydrostatic section that comprises the master cylinder 4, the hydraulic line 5, and the slave cylinder 6, is sensed by a pressure sensor 30 fixed to the hydraulic line 5. The pressure sensor 30 provides a pressure signal also referred to as the actuator pressure signal.

In double clutch systems with actively closed individual clutches, sniffing is impossible while the torque is transmitted by the respective individual clutch. The thermal expansion of the hydraulic fluid may result in distinct engagement travel changes, which may result in very high engaging forces due to the steep gradient of the given characteristic clutch curves. These engaging forces may destroy the mechanical elements of the clutch, the apply bearings, and the hydrostatic system itself. In accordance with an essential aspect of the invention, the pressure sensor 30 is used to detect and avoid mechanical overload of the clutch 10 and of the actuator 19.

The arrows 41 and 45 in FIG. 1 indicate that the pressure signal of the pressure sensor 30 is evaluated in an actuator control 40. The actuator control 40 comprises an actuator control device, which is used to control the position of and monitor the clutch 10, for example. In the actuator control 40, the pressure signal of the pressure sensor is compared to a first pressure limit. If the first pressure limit is exceeded, the actuator motor 22 is deactivated as indicated by arrow 45, to allow the mechanical system to relax due to a passive movement of the actuator 19. This method is very simple and can be robustly implemented in the actuator control device. If the one-and-a-half-processor concept is applied, even a monitoring computer may carry out the method with the first pressure limit. If the first pressure limit is exceeded, a reset or an emergency shut-down may be initiated in the actuator electronics.

Furthermore arrows 42 and 43 indicate that the signal of the sensed pressure is forwarded for further processing to a drive train control. The drive train control, for example, comprises a drive train control device and is used in accordance with a further aspect of the invention to react as the situation requires to a change in the pressure signal of the pressure sensor 30. If the hydraulic fluid pressure sensed by the pressure sensor 30 increases due to thermal expansion resulting, for example, from driving with excess pressure of the clutch 10, a slight, controlled movement of the actuator 19 allows the pressure of the hydraulic medium and thus the engaging force decreases without any noticeable effect on the vehicle behavior.

If the hydraulic fluid pressure sensed by the pressure sensor 30 increases unexpectedly rapidly when the clutch 10 is being closed, the movement of the clutch actuator 19 may be decelerated using an adapted target position specification to avoid an overloading of the clutch 10. In the drive train control 50, the hydraulic fluid pressure sensed by the pressure sensor 30 is compared to a second pressure limit that is lower than the first pressure limit. A comparison between the actuator pressure signal and the second pressure limit usually allows a reaction without any or with only negligible effects on the vehicle behavior. However, when the actuator control 40 detects a serious fault as it compares the actuator pressure signal and the first pressure limit, the clutch actuating system including the clutch 10 may still protect itself, for instance by an emergency shutdown.

The method of the invention is preferably implemented in a pressure measuring range of between 0.5 and 70 bar at a resolution of approximately 0.14 bar and a degree of accuracy of between +/−4.3 percent of the final value.

### REFERENCE NUMERALS

1 clutch actuating system
4 master cylinder
5 hydraulic line
6 slave cylinder
7 slave piston
10 clutch
14 master piston
19 actuator
20 electric-motor actuating drive
22 actuator motor
24 actuator transmission
30 pressure sensor
40 actuator control
41 arrow
42 arrow
43 arrow
45 arrow
50 drive train control

What is claimed is:

1. A method for controlling an automated clutch (10) that is actuated by a hydraulic clutch actuating system including a hydrostatic actuator (19) whose pressure is detected, comprising the step of using a detected pressure of said hydrostatic actuator (19) to detect and avoid undesired overloading of the actuator (19), of the clutch, or of at least one auxiliary device associated with the clutch (10).

2. The method recited in claim 1, wherein a pressure signal of a pressure sensor (30) that senses the pressure of the hydrostatic actuator (19) is detected, evaluated, and processed.

3. The method recited in claim 2, wherein the pressure signal is compared to a first pressure limit and an actuator drive (20) is deactivated when the first pressure limit is exceeded.

4. The method recited in claim 3, wherein the pressure signal is compared to the first pressure limit in an actuator control (40).

5. The method recited in claim 2, wherein the pressure signal is compared to a first pressure value in a drive train control (50).

6. The method recited in claim 2, wherein the pressure signal is compared to a second pressure value in a drive train control (50).

7. The method recited in claim 5, wherein the first pressure limit is a higher pressure value than the second pressure limit.

8. The method recited in claim 3, wherein the actuator (19) is moved slightly by the actuator drive (20) to compensate a pressure increase detected by a pressure sensor (30).

9. The method recited in claim 2, wherein a movement of the actuator (19) during a closing of the clutch (10) is decelerated if the pressure sensor (30) detects an unexpectedly rapid pressure increase.

10. The method recited in claim 1, wherein the pressure signal is used for at least one, for several, or for each of the following clutch control functions:
determining a currently attainable temperature-dependent actuator dynamics;
detecting a reference mark in the clutch actuating system (1);
determining a direction of movement of the clutch actuating system (1);
determining a load on the actuator (19);
determining a force hysteresis in the clutch actuating system (1);
determining a torque hysteresis on the clutch (10);
implementing a plausibility check for a reference mark of the actuator (19) or of the clutch system (1).

11. The method recited in claim 1, wherein the clutch (10) is directly actuated in the hydrostatic actuator (19) including a master cylinder (4) and a slave cylinder (6).
